(19) United States
(12) Patent Application Publication
(10) Pub. No.: US 2016/0063788 A1
(43) Pub. Date: Mar. 3, 2016

(54) Convertible Gaming Device

(71) Applicant: Matthew J. Trahan, Rochester, MA (US)

(72) Inventor: Matthew J. Trahan, Rochester, MA (US)

(21) Appl. No.: 14/836,427

(22) Filed: Aug. 26, 2015

Related U.S. Application Data
(60) Provisional application No. 62/042,753, filed on Aug. 27, 2014.

(51) Int. Cl. G07C 15/00

(52) U.S. Cl. CPC G07C 15/001

(57) ABSTRACT

A device for selecting a random order of sequential alphanumeric indicia such as numbered balls from a set of a selected quantity, including a blower assembly disposed in a housing that, upon selective activation of an on-off switch, circulates air through an airflow tube into a casing cavity to push a single numbered ball contained within a cavity of a transparent casing disposed atop the housing into an upper chamber of a ball-receiving tube having a tube cover with first and second positions. In the second position, the ball is allowed to pass into a smaller transparent casing to stop and display the randomly selected ball. Furthermore, the ball blower device is convertible into a lectern after the large transparent casing is removed from the housing. Progress among players can be tracked using a numeric grid.

### CROSS-REFERENCE TO RELATED APPLICATION

This application is an original provisional application.

### FIELD OF THE INVENTION

This invention relates to gaming devices and more particularly to lottery-type devices that randomly select an object with alphanumeric markings such as a numbered ball and are convertible to other functions.

### BACKGROUND OF THE INVENTION

There are a number of interactive competition games such as fantasy football wherein users compete against each other as managers of virtual teams assembled by “drafting” actual sports players. Activities include drafting, trading, recruiting or discharging players. Typically, rosters of players for the virtual teams are changed each week. It is desirable to randomly generate an order for users to make their selections.

More broadly, gaming devices that randomly generate one or more numbered balls include a device described by Traficant in U.S. Pat. No. 8,480,087 that selects at least one pair of numbered balls as a substitute for rolling dice. Game balls with multiple game indicia are discussed by Ward in U.S. Patent Publication No. 2014/0042696.

Currently, there is a need for a reasonably-priced gaming device configured to generate a random order of sequential alphanumeric indicia such as numbered balls to designate an order for users to compete such as by making draft choices. There is also a need for such a device which serves at least one subsequent function for the users when present at a common location.

### SUMMARY OF THE INVENTION

An object of the present invention is to provide an easy-to-use, reasonably-priced gaming device that randomly selects objects to generate an order of play and is convertible to serve at least one further function.

Another object of the present invention is to provide such a device that can serve as a lectern.

This invention features a gaming device convertible into a lectern, including a housing containing a blower assembly and having an upper surface having a first length and a first width. The device further includes a transparent casing having a lid and a cavity. The casing is removably disposed on a top side of the base in communication with the blower assembly and is capable of holding in the cavity a plurality of objects bearing sequential alphanumeric indicia. The casing includes (1) an object-receiving tube, into which at least one object can be blown by the blower assembly, disposed through the lid and into the cavity and (2) an object capture compartment disposed at the top of the tube. The gaming device further includes a removable upper lectern portion having (1) a pedestal portion capable of being placed on the housing after the casing is removed and (2) a platform disposed on top of the pedestal portion to hold items to be viewed by a user.

This invention may also be expressed as a device for selecting a random order of sequential alphanumeric indicia such as numbered balls from a set of a selected quantity, including a blower assembly disposed in a housing that, upon selective activation of an on-off switch, circulates air through an airflow tube into a casing cavity to push a single numbered ball contained within a cavity of a transparent casing disposed atop the housing into an upper chamber of a ball-receiving tube having a tube cover with first and second positions. In the second position, the ball is allowed to pass into a smaller transparent casing to stop and display the randomly selected ball. Furthermore, the ball blower device is convertible into a lectern after the large transparent casing is removed from the housing. Progress among players can be tracked using a numeric grid.

In some embodiments, the gaming device includes a base and a lockable access door disposed on the base to provide access for repairs and to prevent tampering. A transparent casing, disposed on a top side of the base, includes a continuous outer wall, a lid, and a continuous cavity disposed between the outer wall and the lid. A ball receiving tube is centrally disposed through lid and into the cavity. A ball receptacle is centrally disposed on the tube cover housing. A plurality of holes is disposed in the ball receptacle. A pivoting tube cover is centrally disposed on the lid in a pivoting tube cover housing. In addition, a raised plate is continuously disposed within the casing on a bottom and thereof. Further, an opening centrally disposed within the plate and the bottom end. A vent is disposed on a bottom side of the base.

In certain embodiments, the blower assembly includes a motor and a fan. The motor is disposed within the housing and a fan compartment is centrally disposed within the housing to provide air circulation within the housing, through the airflow tube, through the cavity, into the ball receiving tube, and out the holes in the upper chamber ball receptacle. A fan is disposed within the fan compartment. The fan is in operational communication with the motor. An airflow tube is disposed between a top end of the fan compartment and the opening. The vent permits heat generated by the motor and the fan to escape from the cavity to prevent overheating of the motor and the fan. An on-off switch, which is in operational communication with the motor, is disposed on the base proximal to the casing.

In some embodiments, the instant device also includes a plurality of lightweight hollow air-filled bouncing numbered balls uniquely numbered in a sequence, such as from 1 through 12. Activation and alternate deactivation of the on off switch respectably activates and deactivates the motor. Activation and alternate deactivation of the motor respectively activates and deactivates the fan. Activation of the fan circulates air within the cavity. Upon circulation of air within the cavity, the numbered balls bounce and a single numbered ball randomly enters the ball receiving tube and into a ball receptacle. The plate provides a surface against which the numbered balls can bounce. The casing is transparent to provide visibility of the numbered balls as the numbered balls bounce and a single number ball enters the ball receiving tube and travels up to the ball receptacle. A support shelf is disposed within the base. The support shelf is configured to support the fan in a position suspended within the base above the bottom side. The support shelf increases the life of the motor and the fan over disposition of the motor and the fan on the bottom side of the base by reducing jarring of the motor and the fan during transport.

In one embodiment, to facilitate transport and storage of the device, the housing has a height of approximately 44 inches, a width of approximately 14 inches and a depth of approximately 13 inches while the casing has a height of approximately 12.5 inches, a width of approximately 12 inches and a depth of approximately 12 inches. The ball receptacle and display has a height of approximately 2.5 inches, a height of approximately 2.5 inches and a depth of approximately 2.5 inches. A plurality of caster wheels is disposed on the bottom side of the base so that the device can be rolled to varying locations. While the present device can be a floor version, a tabletop version is also contemplated for mounting to a standard table. The tabletop version includes the casing and the numbered balls as well as a blower assembly and an on-off switch.

This device is also useful with a numeric grid which includes an ascending set of numbers from, but not limited to, 1 through 150 or 1 through 204 in a uniquely designed serpentine pattern of draft pick order divided into, but not limited to, 15 rows of 10 columns or 17 rows of 12 columns. The rows represent sequential rounds of draft selections. The numeric grid is printed in some embodiments and, in other embodiments, is an electronic look-up table, preferably as part of a software application according to another embodiment of the present invention.

### BRIEF DESCRIPTION OF THE DRAWINGS

In what follows, preferred embodiments of the invention are explained in more detail with reference to the drawings, in which:

FIG. 1 is a schematic front perspective view of a ball blower apparatus according to the present invention having a transparent casing and a base;

FIG. 2. is a rear perspective view of the ball blower apparatus;

FIG. 3 is a cross sectional side view along lines 3-3 of FIG. 2;

FIG. 4 is a front view of the transparent casing of FIGS. 1-3;

FIG. 5 is a rear view of the base plus a platform to establish a lectern;

FIG. 6 is a front view of the numbered balls of FIGS. 1 and 3;

FIG. 7 is a rear view of the platform for the lectern of FIG. 5;

FIG. 8 is a side view of the platform of FIG. 7;

FIG. 9 is a top view of a numeric grid utilized according to the present invention;

FIG. 10 is a top view of an alternative numeric grid;

FIG. 11A is a schematic illustration of successive screen views on a display;

FIG. 11B is a schematic illustration of a draw function to generate a number;

FIG. 12A is an illustration of an icon that initiates a selection process utilizing the present invention;

FIG. 12B is an illustration of successive screen views on a display;

FIG. 12C is an illustration of a screen view of blocks of Average Draft Position with a list of selected players in the lower right corner of the screen; and

FIG. 13 is a flowchart indication the operation of one system according to the present invention.

### DETAILED DESCRIPTION OF THE PRESENTLY PREFERRED EMBODIMENTS

This invention may be accomplished by a device for selecting a random order of sequential alphanumeric indicia such as numbered balls from a set of a selected quantity, including a blower assembly disposed in a housing that, upon selective activation of an on-off switch, circulates air through an airflow tube into a casing cavity to push a single numbered ball contained within a cavity of a transparent casing disposed atop the housing into an upper chamber of a ball-receiving tube having a tube cover with first and second positions. In the second position, the ball is allowed to pass into a smaller transparent casing to stop and display the randomly selected ball. Furthermore, the ball blower device is convertible into a lectern after the large transparent casing is removed from the housing. Progress among players can be tracked using a numeric grid.

In one construction, the device is configured to generate a random order of numbered balls and serves a secondary function, such as converting into a lectern. The device includes a base containing a blower assembly which includes a fan and a motor to drive the fan; a transparent casing which includes an outer wall, a lid, and a cavity there between; a ball receiving tube centrally disposed in the lid; a pivoting tube cover centrally disposed in the tube cover housing; an on-off switch in operational communication with the motor and, in turn the fan, which circulates air through an airflow tube and into the cavity thereby randomly pushing a single numbered ball of a plurality of numbered balls contained within the cavity through the ball receiving tube and into the ball receptacle.

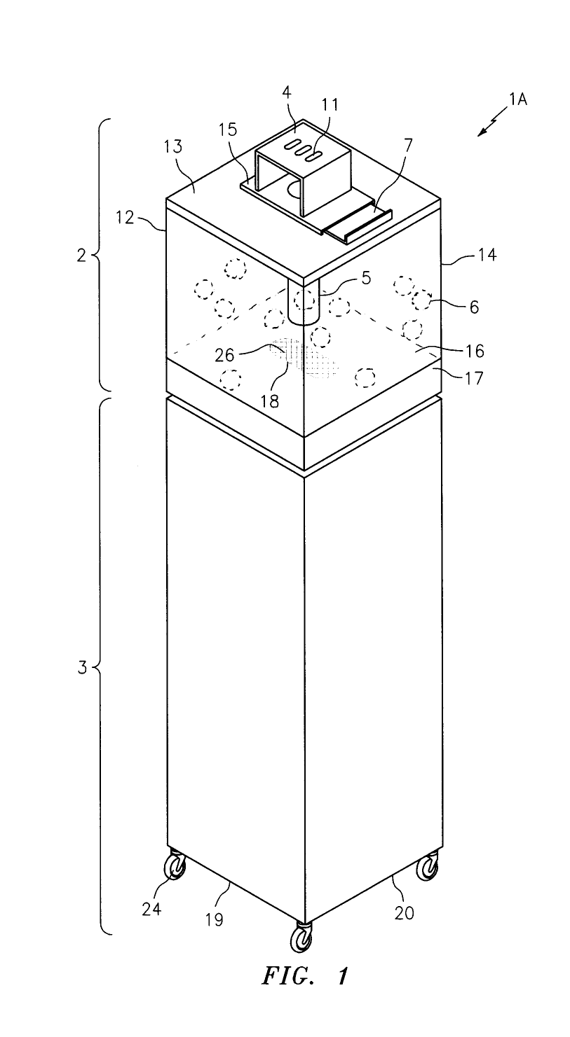

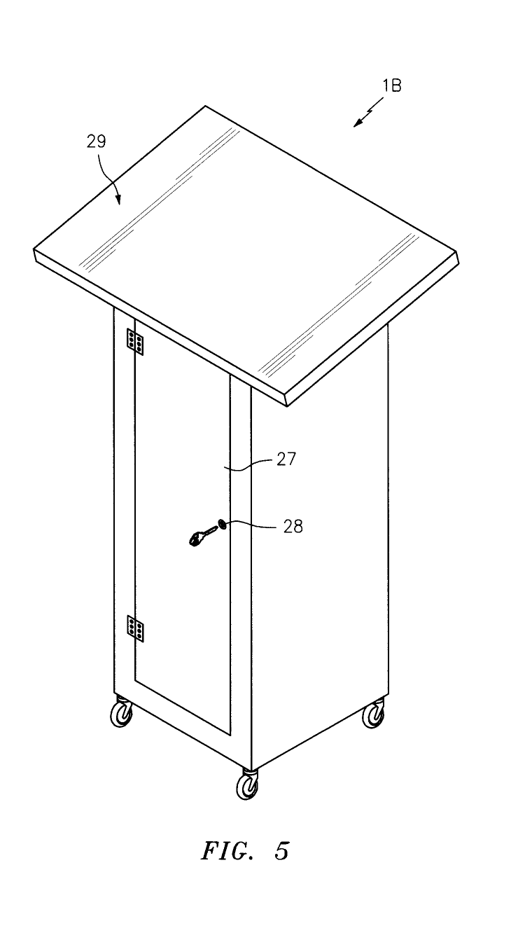

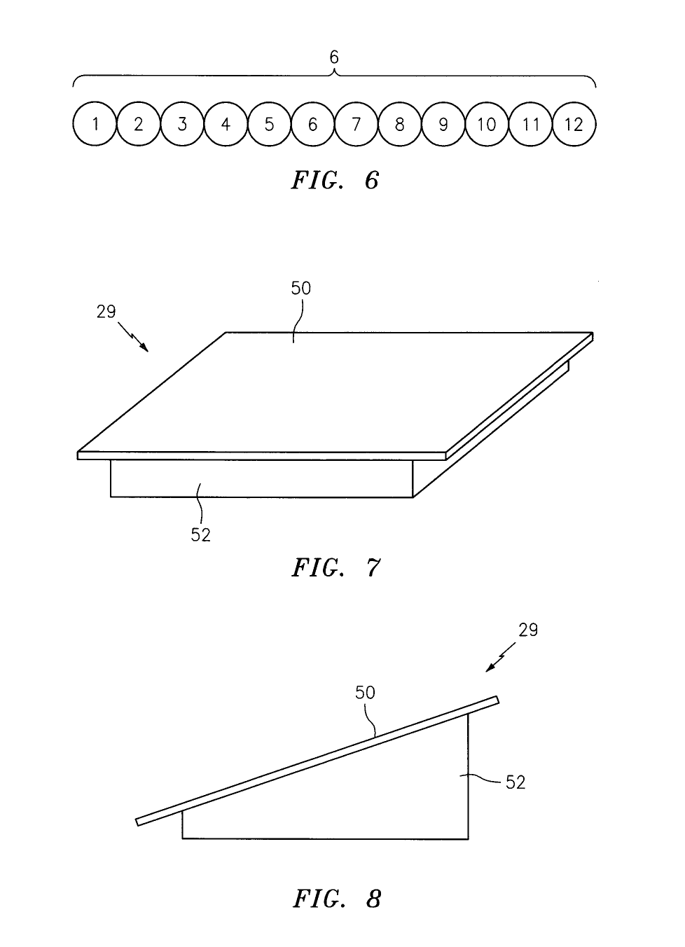

FIG. 1 shows a front view of a ball blow apparatus 1 useful for, but not limited to, the draft order selection process in fantasy sports leagues. With the regard to the present invention, the ball blow apparatus 1A converts into a lectern 1B (FIG. 5) having a removable upper lectern portion 29, FIGS. 7 and 8, having a pedestal portion 52 capable of being placed on the housing after the casing is removed and a platform 50 disposed on top of the pedestal portion to hold items to be viewed by a user.

As further shown in FIG. 1 the ball blow apparatus includes a transparent casing 2, a base 3 which is also referred to as a housing, a smaller transparent ball receptacle and display casing 4, a plurality of holes 11 is disposed in the ball receptacle and display casing 4, a ball receiving tube 5, attraction balls 6, and a pivoting tube cover 7 disposed in a tube cover housing 15.

The transparent casing 2 includes a continuous outer wall 12. A lid 13 is disposed on the casing 2. A continuous cavity 14 is disposed between the outer wall 12 and the lid 13. A ball receiving tube 5 is centrally disposed through the lid 13 and into the cavity 14. A ball receptacle 4 is centrally disposed on the tube cover housing 15 and directly above the ball receiving tube 5. A pivoting tube cover 7 is centrally disposed on the lid 13 in a pivoting tube cover housing 15.

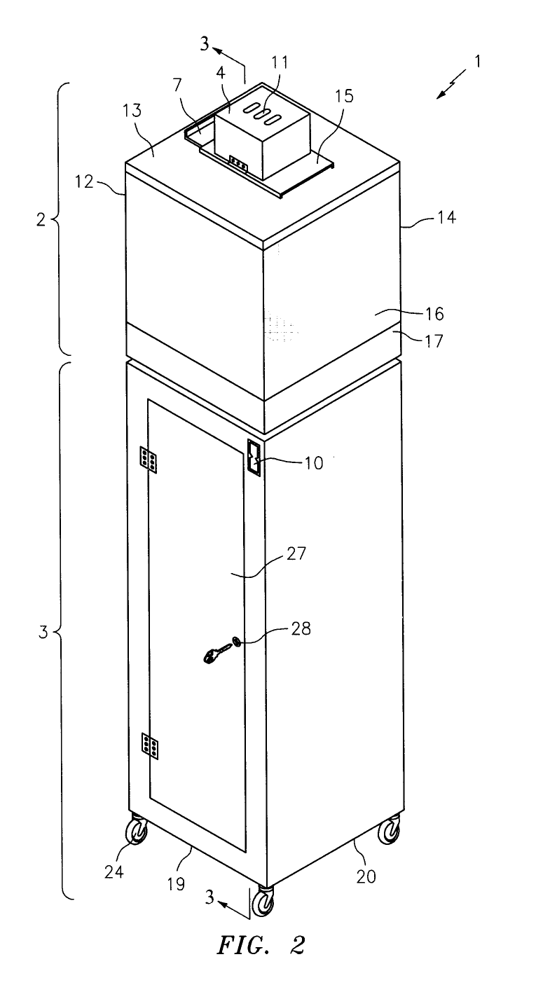

A first lock 28 (FIG. 2) is disposed on the access door 27 (FIG. 2). In addition, a raised plate 16 is continuously disposed within the casing 2 on a bottom end 17 thereof. Furthermore, an opening 18 covered by a screen 26 is centrally disposed within the plate 16 and the bottom end 17. A vent 19 is disposed on a bottom side 20 of the base 3. The transparent casing 2 the ball receptacle and display casing 4 and the ball receiving tube 5 may be formed from any material that is transparent so that players can see the attraction balls 6 in the casings.

Suitable materials for the transparent casings include, but are not limited to glass, plastic, plexiglass, acrylic, butyrate, PETG (polyester terephthalate glycol), and Kydex commercially available from Kleerdex company. Attraction balls 6 should be light enough that they can be moved easily around the inside of the transparent casing 2 by a forced fluid such as air. In one embodiment the attraction balls 6 are made of plastic and are similar to ping-pong balls. Attraction balls 6 however, may also be constructed of rubber, foam, or the like. The player attraction balls 6 however, may be only one color or a combination of different colors, the player attraction balls 6 also may have a variety of markings such as stripes, numbers, letters, symbols and or geometric shapes.

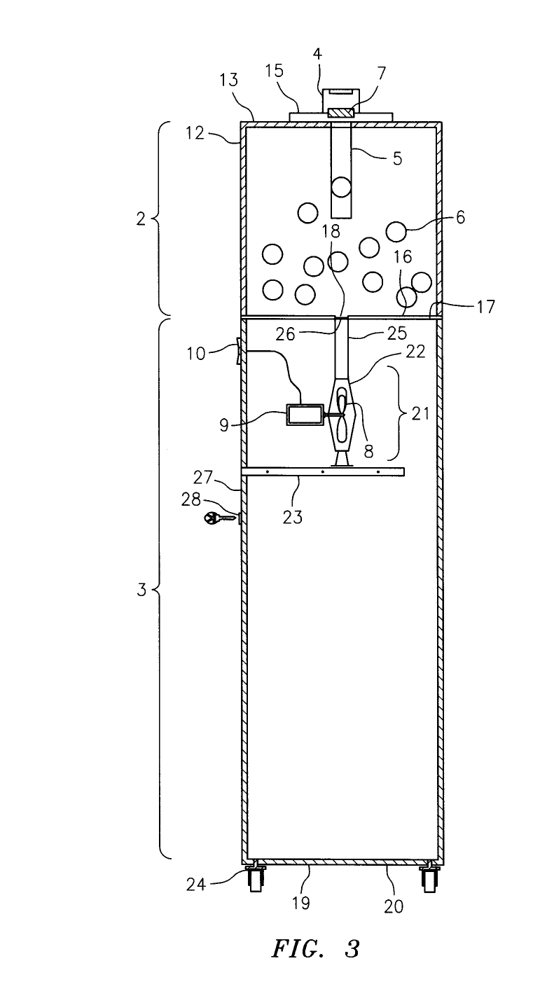

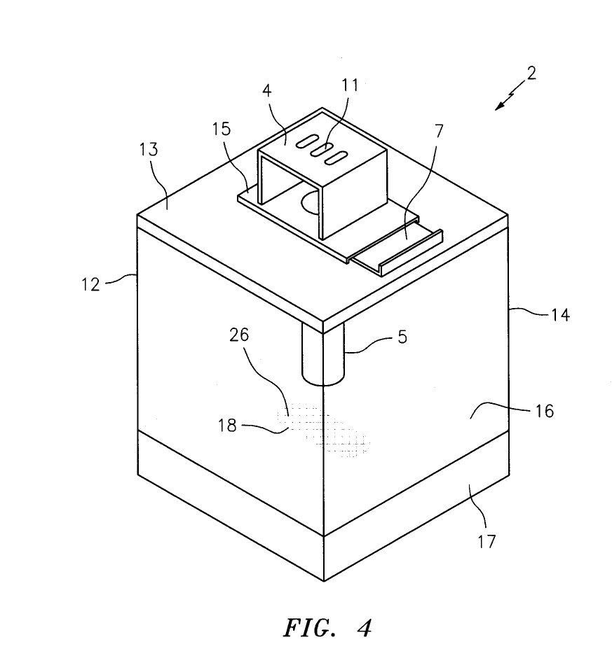

One construction of the present device also includes a blower assembly 21 (FIG. 3). The blower assembly 21 is centrally disposed on a support shelf 23 (FIG. 3) within the base 3 and includes a motor 9 (FIG. 3) a fan 8 (FIG. 3) a fan compartment 22 (FIG. 3) that houses the fan 8 (FIG. 3) and an airflow tube 25 (FIG. 3). The fan 8 (FIG. 3) is used to generate a current of air which flows up into the transparent casing 2 and causes the attraction balls 6 to randomly move inside the transparent casing 2 and out through a plurality of holes 11. The fan 8 (FIG. 3) is activated by a motor 9 (FIG. 3) which is turned on and off by a switch 10 (FIG. 3). The support shelf 23 (FIG. 3) is configured to support the blower assembly 21 (FIG. 3) in a position suspended within the base 3 above the bottom side 20 of the base 3. The transparent casing 2 and base 3 must be properly vented by any method well-known in the art in order to prevent a buildup of air pressure in the transparent casing 2 and or the base 3.

In order to transport and store the device 1, the base 3 preferably has a height of approximately 44 inches, a first width of approximately 14 inches and a depth or first length of approximately 13 inches while the casing 2 has a height of approximately 12.5 inches, a width of approximately 12 inches and a depth of approximately 12 inches. Preferably, the pedestal portion 52 has a second length at least as great as the first length of the base 3 and a second width at least as great as the first width of base 3. The ball receptacle and display 4 has a height of approximately 2.5 inches, a width of approximately 2.5 inches and a depth of approximately 2.5 inches. A plurality of caster wheels 24 is disposed on the housing bottom side 20 so that the device can be rolled to varying locations. In general, the fan 8 (FIG. 3) will be turned on and the attraction balls 6 will move inside the transparent casing 2 when the motor 9 (FIG. 3) is activated by the on off switch 10 (FIG. 3) which is disposed on the base 3 proximal to the transparent casing 2.

This gaming device can be augmented with a numeric grid having an ascending set of numbers from, but not limited to, 1 through 204 in a uniquely designed serpentine pattern divided into, but not limited to, 17 rows of 12.

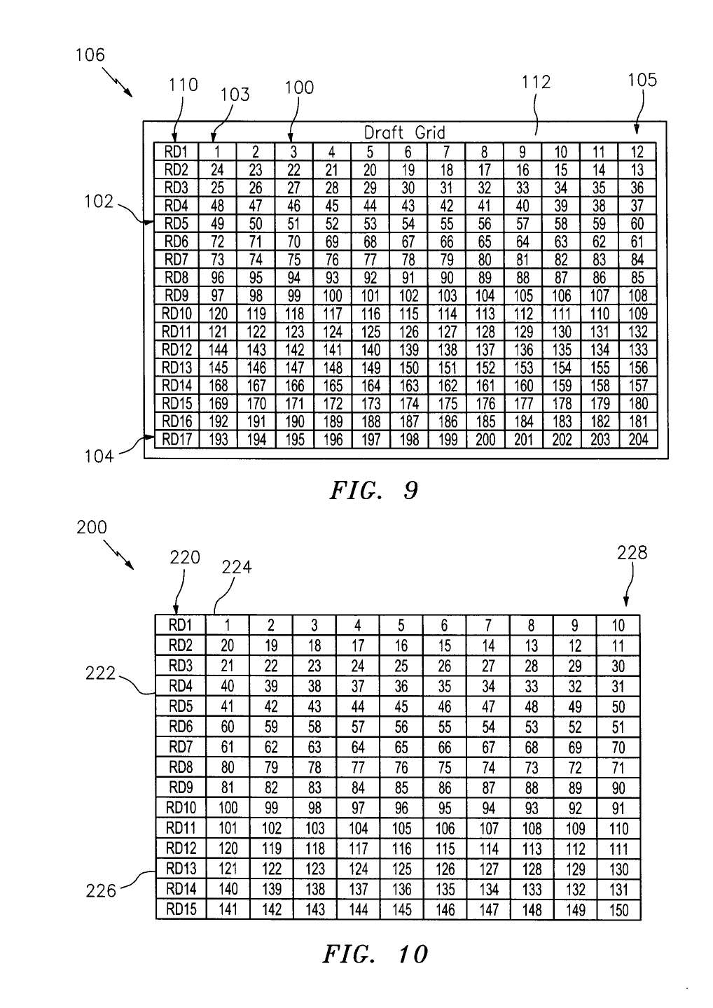

Referring to FIGS. 9 and 10, preferred embodiments of the present numeric grids 100 and 200 are illustrated. The numeric grid 100 is designed to determine overall draft picks in, but not limited to, fantasy sports league drafts. The numeric grid 100 is divided into, but not limited to, 17 horizontal rows 102 of rounds (RD) 104 listed in a first column 110. Each horizontal row 102 contains, but is not limited to, 12 vertical rows or columns 103, representing 12 users acting as owners or managers of a team, including column 105 in this construction containing draft order numbers 12, 13, 36, 37, . . . 180, 181 and 204. The numeric grid 100 is disposed on a sheet of material 106 within a lamination 105 for rigidity, protection and durability in this construction.

The numeric grid 200 is designed to determine overall draft picks in, but not limited to, fantasy sports league drafts and is divided into, but not limited to, 15 horizontal rows 222 of, but not limited to, 10 vertical rows 224. Rounds (RD) 226 are disposed in a first column 220. End column 228 in this construction contains draft order numbers 10, 11, 30, 31, . . . 130, 131 and 150.

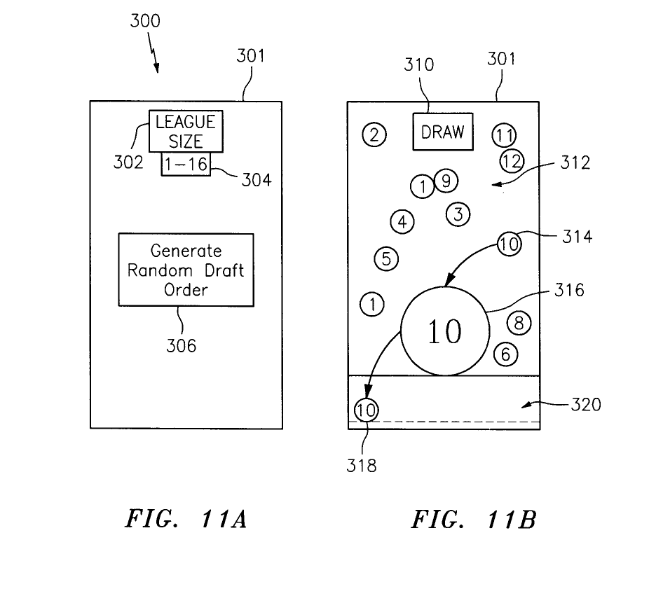

Screen view 300, FIG. 11A, represents several views that can be generated by a software program, application or system according to the present invention as appearing on the display screen 301 of a smart-phone, tablet, lap-top or other computing device. After the program is initiated, the size of the league, that is, the number of users or owners, is selected, as indicated by a LEAGUE SIZE window, button or soft-key 302. The user selects a league size ranging from 1 to 16 in this construction, window 304.

A random draft order is then generated, window 306, such as by using the physical convertible gaming device described above or, in an another construction implemented by software, by a DRAW feature 310 shown on screen 301 in FIG. 11B. After DRAW feature 310 is initiated, a bouncing or mixing of numbered objects 312 is shown. At a pre-selected interval, such as 5 or 10 seconds, the system randomly selects and enlarges one of the objects such as object 314 which is then enlarged as indicated by enlarged ball 316 bearing the numeral “10”, such as currently achieved by some Keno-type games. The selected numeral 10 is then placed at the bottom of the screen in position 318 of a row 320. Other users in the league then press window 306, FIG. 11A in some constructions and, in other constructions, the system periodically generates additional numerals for row 320, FIG. 11B, according to the size that was selected for the league utilizing window 302, FIG. 11A.

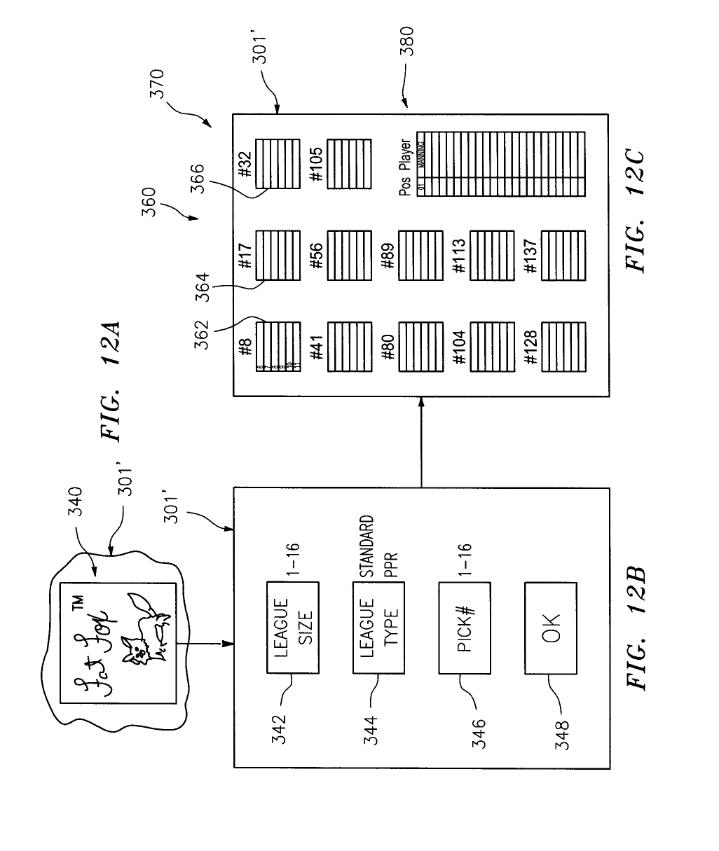

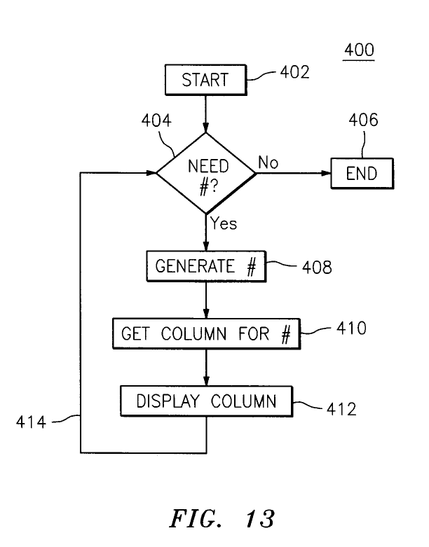

Another system according to the present invention is illustrated in FIGS. 12A-12C. An icon 340 on a screen 301′ is selected, FIG. 12A, and then the league size is selected via a button 342, FIG. 12B, such as for 1 to 16 users. The league type is selected by a button 344, such as standard or PPR (Points-Per-Reception). Button 346 labelled “Pick #” initiates the random generation of a number as described above, or enables a user to enter his or her particular randomly-generated number. Button 348 labelled “OK” confirms the entry or selection of data and initiates view 360, FIG. 12C.

View 360 contains a series of blocks of 5 ADP (Average Draft Position) of sports players per block. If a user was randomly assigned the eighth draw or draft position for the 12-person league illustrated in FIG. 9, then the user will access blocks 362, 364 and 366 at draft choices #8, #17 and #32 during Rounds 1-3, as indicated by indicia 370, FIG. 12C. As each sports player is selected by the user, the player's name is added to list 380, such as “Manning” representing a quarterback as a first choice by the user.

Operation of a system 400 according to the present invention is schematically illustrated in FIG. 13. The logic is initiated, step 402, and the system determines whether a randomly-generated number is needed, step 404, such as by prompting a user to request a number. If no numbers are needed, the logic ends, step 406. If a number is needed, a number is generated, step 408, as described above. A column is obtained, step 410, that corresponds to that number, such as the columns contained in grids 100 or 200, FIGS. 9 and 10. The appropriate column is displayed, step 412, in some constructions and, in other constructions, blocks of ADP players are generated as illustrated in FIG. 12C. The logic returns via loop 414 to decision step 404, and the logic continues until no further numbers are needed, step 406.

Although specific features of the present invention are shown in some drawings and not in others, this is for convenience only, as each feature may be combined with any or all of the other features in accordance with the invention. While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

It is the intention, therefore, to be limited only as indicated by the scope of the claims appended hereto. Other embodiments will occur to those skilled in the art and are within the following claims.

What is claimed is:

1. A gaming device convertible into a lectern, comprising:
a housing containing a blower assembly and having an upper surface having a first length and a first width;
a transparent casing having a lid, a cavity, and being removably disposed on a top side of the base in communication with the blower assembly, the casing capable of holding in the cavity a plurality of objects bearing sequential alphanumeric indicia, the casing including (1) an object-receiving tube, into which at least one object can be blown by the blower assembly, disposed through the lid and into the cavity and (2) an object capture compartment disposed at the top of the tube; and
a removable upper lectern portion having (1) a pedestal portion capable of being placed on the housing after the casing is removed and (2) a platform disposed on top of the pedestal portion to hold items to be viewed by a user.

2. The gaming device of claim 1 wherein the pedestal portion has a second length at least as great as the first length and a second width at least as great as the first width.

3. A gaming device configured to generate a random order of numbered balls for fantasy league drafts and which is capable of serving a secondary function of converting into a lectern, the device comprising:
a base including an access door disposed on the base, and a first lock disposed on the access door;
a transparent casing disposable on a top side of the base, the transparent casing including:
a continuous outer wall;
a lid disposed on the casing;
a continuous cavity disposed between the outer wall and the lid;
a ball receiving tube centrally disposed through the lid and into the cavity;
a tube cover housing centrally disposed on the lid;
a pivoting tube cover centrally disposed in the tube cover housing;
a ball receptacle and display centrally disposed on the tube cover housing;
a plurality of holes disposed in the ball receptacle;
a raised plate continuously disposed within the casing on the bottom end thereof;
an opening centrally disposed within the plate and the bottom end; and
a screen which is centrally disposed on a bottom side of the raised plate covering the opening, wherein the screen prevents an object contained within the cavity from entering the airflow tube;
a blower assembly disposed within the base and including:
a motor;
a fan compartment;
a fan disposed within the fan compartment, wherein the fan is in operational communication with the motor;
an airflow tube disposed between a top end of the fan compartment and the opening;
an on-off switch disposed on the base proximal to the casing, wherein the on-off switch is in operational communication with the motor; and
a vent disposed on a bottom side of the base;
a plurality of lightweight hollow air-filled bouncing balls including at least twelve numbered balls uniquely numbered from 1 through 12;
wherein activation and alternate deactivation of the on-off switch respectively activates and deactivates the motor;
wherein activation and alternate deactivation of the motor respectively activates and deactivates the fan;
wherein activation of the fan circulates air within the cavity; and
wherein upon circulation of air within the cavity a single numbered ball randomly enters the ball receiving tube and up into the ball receptacle.

4. The gaming device of claim 4 further comprising:
a support shelf disposed within the housing, the support shelf is configured to support the fan in a position suspended within the base above the bottom side.

5. The gaming device of claim 4 further comprising:
a plurality of caster wheels disposed on the base bottom side.

6. A gaming device configured to generate a random order of numbered balls for fantasy league drafts which serves a secondary function, converting into a lectern, the device comprising:
a base including an access door disposed on the base and a first lock disposed on the access door;
a transparent casing disposed on a top side of the base, the transparent casing including:
a continuous outer wall;
a lid disposed on the casing;
a continuous cavity disposed between the outer wall and the lid;
a ball receiving tube centrally disposed through the lid and into the cavity;
a tube cover housing centrally disposed on the lid;
a pivoting tube cover centrally disposed in the tube cover housing;
a ball receptacle and display centrally disposed on the tube cover housing;
a plurality of holes disposed in the ball receptacle;
a raised plate continuously disposed within the casing on the bottom end thereof;
an opening centrally disposed within the plate and the bottom end; and
a screen which is centrally disposed on a bottom side of the raised plate covering the opening, wherein the screen prevents an object contained within the cavity from entering the airflow tube;
a blower assembly including:
a motor disposed within the base;
a fan compartment centrally disposed within the base;
a fan disposed within the fan compartment, wherein the fan is in operational communication with the motor;
an airflow tube disposed between a top end of the fan compartment and the opening;
an on-off switch disposed on the base proximal to the casing, wherein the on-off switch is in operational communication with the motor; and
a vent disposed on a bottom side of the base;
a plurality of lightweight hollow air-filled bouncing balls including at least twelve numbered balls uniquely numbered from 1 through 12;
wherein activation and alternate deactivation of the on-off switch respectively activates and deactivates the motor;
wherein activation and alternate deactivation of the motor respectively activates and deactivates the fan;
wherein activation of the fan circulates air within the cavity;
wherein upon circulation of air within the cavity a single numbered ball randomly enters the ball receiving tube and up into the ball receptacle.
a support shelf disposed within the housing, the support shelf configured to support the fan in a position suspended within the base above the bottom side of the base;
a plurality of caster wheels disposed on the base bottom side;
wherein the base has a height of approximately 44 inches, a width of approximately 14 inches and a depth of approximately 13 inches;
wherein the casing has a height of approximately 12.5 inches, a width of approximately 12 inches and a depth of approximately 12 inches;
wherein the ball receptacle and display has a height of approximately 2.5 inches, a width of approximately 2.5 inches and a depth of approximately 2.5 inches.

7. The gaming device of claim 1 further including a numeric grid configured to ascend in numerical order from, but not limited to, 1 through 204 in a serpentine pattern, the numeric grid comprising:
17 horizontal rows called rounds; and
12 vertical rows.

8. The gaming device of claim 7 wherein the numeric grid is disposed on a sheet of material and covered with a protective lamination.

9. The gaming device of claim 1 further including a numeric grid configured to ascend in numerical order from, but not limited to, 1 through 150 in a serpentine pattern, the numeric grid comprising 15 horizontal rows called rounds; and 10 vertical rows.
